(19) United States
(12) Patent Application Publication
(10) Pub. No.: US 2022/0222239 A1
(43) Pub. Date: Jul. 14, 2022

(54) METHOD TO IMPROVE THE ACCURACY OF FORMATION TOP PICKS

(71) Applicant: Saudi Arabian Oil Company, Dhahran (SA)

(72) Inventors: Marwah AL ISMAIL, Dhahran (SA); Mokhles M. MEZGHANI, Dhahran (SA); Mohammed AL AL-MASRAHY, Dhahran (SA)

(21) Appl. No.: 17/148,177

(22) Filed: Jan. 13, 2021

(51) Int. Cl. G06F 16/23; E21B 49/00; G01V 5/04; G06F 16/2457; G06Q 50/02

(52) U.S. Cl. CPC G06F 16/2365; E21B 49/00; G06Q 50/02; G06F 16/24578; G01V 5/04

(57) ABSTRACT

A method for identifying the most representative well logs for the purpose of locating the top of a hydrocarbon-bearing formation employs the Pearson Correlation Coefficient by quantifying the consistency of historic previous top formation picks from a historic database of well data and corresponding logging data associated with each well in a defined oil field to provide Well Correlation Scores from which are derived Log Correlation Scores that are employed in accordance with the disclosure to provide a Top Correlation Score that is indicative of the relative reliability of the location of a top pick for a specific well in the defined oil field.

### BACKGROUND OF THE DISCLOSURE

### 1. Field of the Disclosure

This disclosure relates to the analysis of well logging data from new non-producing wells in reservoir rock to identify the uppermost region of a hydrocarbon-bearing formation in preparation for opening the well for production.

### 2. The Prior Art

The accurate identification of the tops of reservoir formations, commonly referred to as formation top picking, is essential in the oil and gas industry. This information is important and sensitive because small changes in the depths of hydrocarbon-producing reservoir regions can have a significant impact on the calculated reserves and volumetrics for a given formation. The ability to accurately identify the top or uppermost region of the stratum of hydrocarbon reserves of producing reservoir rock is important because total hydrocarbon production can be effected by relatively small changes in the depth of producing reservoir rock. The value of formation top picks are based on accurately identifying the physical changes from one formation to another formation as, for example, a change from Clastics to Carbonates.

The current process of formation top picking can be characterized as “manual” and is based on the identification by a geoscientist of similar trends among the logs of the new wells, i.e., wells without picks, and the logs of so-called training wells for which top picks have been previously made. Currently, a geoscientist looks at 2 or 3 of what are deemed to be the most representative logs to find points of change in the logs in order to estimate the location of the top of the hydrocarbon-bearing stratum or strata in the formation. The most representative logs are selected based on the knowledge and experience of the geoscientist. It will be understood that identifying the location of the top pick is highly dependent on the expertise of the geoscientist. Both the selection of the most representative logs and subsequently identifying the location of top pick is highly subjective and consequently, is prone to human errors that can affect the accuracy of the top picks.

The development of previously drilled and logged wellbores in a given region or field typically occurs over an extended period of time, geophysicists periodically review the previously picked formation tops and modify them, if deemed appropriate, based on enhanced knowledge derived from additional well logging data and actual production records from wells in the same field or region. This reevaluation process takes a significant amount of time since the geoscientists cannot examine and compare data from all wells at the same time. The nature of this stepwise reevaluation process can also lead to errors in the identification of proposed changes to the formation top picks.

In order to avoid or minimize the element of human error, it would be desirable to provide a method to automate and mathematically standardize the process using statistical analyses that will provide consistent results.

### SUMMARY OF THE INVENTION

The present disclosure is directed to a method for improving the accuracy of identifying the location of the top of a subterranean geological formation by statistically analyzing existing historical oil well log data obtained from numerous wells in a predetermined region of reservoir rock that contains hydrocarbons, i.e., oil and gas. As used herein, the terms “formation top pick”, “formation top picks” and “top picks” are used interchangeably and mean the identification of the top or uppermost region of a particular subterranean geological formation of hydrocarbon-bearing reservoir rock. The hydrocarbons present in the region below the top pick can be oil and/or gas.

In order to improve the accuracy and reliability of the top picks, the logs that are most representative of the physical characteristic of the physical changes from one formation to another formation must be selected. These changes in formation characteristics can effect certain types of logs, but not others. As used in this disclosure, the selected logs are “top dependent”. For example, a well log providing data on porosity might be useful for identifying formation top “A”, but not useful for identifying formation top “B”.

Well logging using various types of sensors is well established and used for the identification of various properties during exploratory well drilling for hydrocarbon-bearing subterranean rock formations. The data from the well logging instruments is recovered and can be converted into both graphic representations and/or numerical values which are evaluated and analyzed by petroleum, geologists, geoscientists, exploration managers and well engineers. The types of log data commonly utilized by geoscientists in their analysis include gamma ray (GR), porosity and density, and these will be employed in the analyses that follow as representative in the art for the purpose of the present disclosure. It will be understood that data relating to numerous other properties and characteristics are collected during well logging that are categorized, organized and retrievably stored for each well in appropriate memory devices for access by microprocessors.

In the development of a new oil field, one or more “training wells” are drilled and carefully studied to identify a variety of characteristics including, for the purpose of the present disclosure, the location of the subterranean geophysical regions. Each new well is logged during drilling, e.g., using specialized collecting instruments including those for at least the three types of data identified above. The well logging instruments are able to collect the data while drilling from the drill bit or an adjacent logging tool section as the drill moves through the formations. It will be understood that as the drilling of the borehole proceeds, steel well casing is introduced into the borehole to prevent or minimize the flow of hydrocarbons and/or water from the reservoir rock, and any unconsolidated material through which the drilling operation is passing. In order to eventually recover the hydrocarbons, the casing must be penetrated using explosive charges that create holes at carefully prescribed locations below the earth's surface and, in some cases, to also penetrate the hydrocarbon-bearing strata to encourage the increased flow of hydrocarbons (gas and/or oil) into the perforated sections of the well casing for recovery at the earth's surface. These operations are expensive and time-consuming. It follows that the ability to accurately identify the top of a given hydrocarbon-bearing formation, i.e., the top pick, is important in order to efficiently maximize and optimize the subsequent production of hydrocarbons from productive reservoir rock.

As will be appreciated by those familiar with the art, the drilling of the well bore may pass through more than one productive stratum. It is also relevant to the present disclosure that one or more of the hydrocarbon-bearing strata may be inclined to the vertical well bore and be present in a “wave” or undulating pattern. So-called horizontal well drilling techniques have been developed to maximize the recovery from a given stratum by allowing the drill to be selectively diverted from the vertical. This recovery method is analogous to that of coal mining in which the tunnel follows the underground coal vein.

In accordance with prior art methods employed in the field, geoscientists look at the well log data from the training wells and compare it to the corresponding equivalent data, e.g., gamma ray, porosity and density from the new wells in that field. Based upon their expertise and experience, the geoscientists subjectively identify one or more top picks along a given well bore. This method is prone to inaccuracy as a result of the principal reliance on subjective human judgment that in turn is based on an individual's training and experience, so that this initial determination of the formation top pick is more of an art than a science.

The present method for the retrospective statistical analysis of historic well logging data from a plurality of wells in an oil field is based upon a specific application of the principles associated with the Pearson correlation coefficient data, which is a known methodology for analyzing a significant amount of data points or data sets to provide a more accurate determination upon which to make a decision than can otherwise be derived from, e.g., a visual observation of graphic displays. The Pearson correlation coefficient which is calculated as described below is expressed as a numerical value in decimal form which is typically less than 1.0, where 1.0 represents a complete correlation between the data analyzed.

The historical data is analyzed in accordance with the method of the present disclosure by application of the Pearson Correlation Coefficient (PCC) as follows:

$${ρ}_{xy} = \frac{{\sum }_{i = 1}^{N} ( {X}_{i} - \overline{X} ) ( {Y}_{i} - \overline{Y} )}{\sqrt{{\sum }_{i = 1}^{N} {( {X}_{i} - \overline{X} )}^{2}} \sqrt{{\sum }_{i = 1}^{N} {( {Y}_{i} - \overline{Y} )}^{2}}} \qquad ( 1 )$$

where:

ρ_{xy} is the Pearson Correlation Coefficient (PCC) between well X and well Y;

N is the total number of data points in the Correlation Window;

Xᵢ is the i^{th} point for well X;

X̅ is the average for the points within the Correlation Window for well X;

Yᵢ is the i^{th} point for well Y; and

Y̅ is the average for the points within the Correlation Window for well Y.

The Correlation Window is a predetermined region in which the location of the top pick is centered. In a vertical bore hole, it is a vertical interval having upper and lower bounds. The interval is measured in conventional units. For the purposes of the present disclosure, the units are expressed in feet.

As will be understood by those of skill in the art, each logging tool generates data points as it passes through the well bore and the data points are linearly spaced at locations that are eventually recorded in the indexed database for that log and the well from which the logging data was collected, and the depth of each data point.

More specifically, this disclosure provides a method or process for identifying the most representative logs using the Pearson Correlation Coefficient (PCC) by quantifying the quality of previous individual top picks recorded in the historic database across different wells and their respective logs. In a preferred embodiment, all available logs are considered. The two principal correlation scores employed to determine whether a specific well and a specific log includes a representative or characteristic signature of the top pick when compared to the other wells and logs are referred to in this disclosure as the “Well Correlation Score” and the “Log Correlation Score”. Using these two scores in accordance with the method of the present disclosure, a “Top Correlation Score” is calculated that provides an indication of the consistency of the location of the top pick with respect to the log signature for all other wells used in the method.

The present disclosure provides a method to standardize the evaluation of top picks employing this statistical analysis to identify those logs that most accurately and reliably portray the physical changes when the logging instrument passes from one formation to another, thereby avoiding or minimizing the human-introduced errors inherent in the prior art method. The present method includes analyzing all of the data previously collected utilizing programs to process the data in a series of steps which rely on the calculation of values that are utilized in subsequent steps.

In a further embodiment of the present disclosure, a method employing an optimization algorithm to identify proposed changes to the top picks previously entered in the historical database is provided. In this embodiment, the optimization algorithm performs a re-assessment of the previously picked formation tops and identifies alternative locations exhibiting a higher value for the top score.

As is explained in more detail below, the processing of the log data to arrive at a value for a given well is iterative and the calculations are repeated as necessary to obtain the maximum value of the Top Correlation Score or, alternatively, until a minimum threshold in the changes in the depth of the top pick is reached.

As used herein, the term “training well” means a producing well in the defined oil field for which well log data exists that corresponds to the actual physical location of the top of the formation that defines the hydrocarbon-bearing stratum.

### BRIEF DESCRIPTION OF THE DRAWINGS

The method of the present disclosure will be described in more detail below, and with reference to the attached drawings in which the same number is used to identify the same or similar elements and functions, and where:

FIG. 1 is a simplified process flow diagram representing a generalized embodiment of the present disclosure;

FIG. 2 is a simplified process flow diagram illustrating an embodiment for determining the Well Correlation Score for a given well compared to a series of wells;

FIG. 3 is a simplified process flow diagram illustrating an embodiment for determining the Log Correlation Score for a given log compared to other logs;

FIG. 4 is a simplified high level process diagram illustrating the determination of the Top Correlation Coefficient for a given top pick selected from a historical database of wells and their associated log;

FIG. 5 is simplified process flow diagram illustrating an embodiment employing an optimization algorithm to selectively improve the value of the Top Correlation Score for top picks; and

FIG. 6 is a graphic plot that is representative of gamma ray well logging data from four wells that are marked to show the respective Correlation Window for each plot.

### DETAILED DESCRIPTION OF THE INVENTION

In the description that follows, it will be understood that all wells, including both “training wells” and new non-producing wells or wellbores in a defined oil field or in a predetermined comparable geological region have been previously logged to provide numerous logs, including those for gamma ray (GR), porosity and density data, and that the data corresponding to all of the logs for each of the wells is indexed and retrievably stored in memory as a retrievable database for use in the processes of the present disclosure as described in detail below. The data identifying the geographical location of each well in the field or region is indexed and stored in the database along with its relevant characteristics, e.g., wellbore, depth, etc.

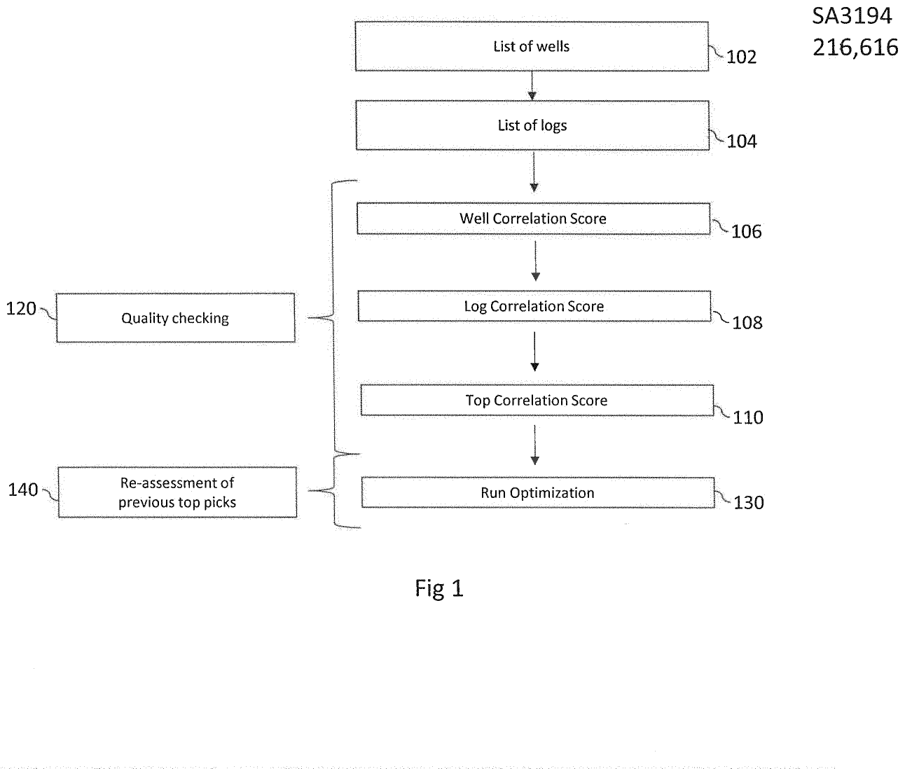

Referring to FIG. 1, the elements and process steps employed in the practice of the present disclosure are shown diagrammatically as the List of Wells (102) that includes the indexed database for each of the wells in the field or region identified as, e.g., Well 1, Well 2 . . . Well X. The second indexed database referred to as the List of Logs (104) includes the logging data that will be used in the analyses. For the purposes of an exemplary representative description of the present process, the number of logs employed is limited to the gamma ray (GR), porosity and density logs for each of the wells in the List of Wells (102).

As explained above and in further detail below, a Pearson Correlation Coefficient is obtained as comparisons are made for each well and other selected wells, and for each of the types of logs selected for the respective wells to calculate the Well Correlation Score (106), the Log Correlation Score (108) and the Top Correlation Score (110). The Top Correlation Score is determined from a summation of the Log Correlation Scores divided by the total number of logs that had at least a predetermined threshold value. For purposes of the present description, these will be limited to the gamma ray (GR), porosity and density logs and the determination of the three Correlation Scores (106, 108, 110) constitutes the step of Quality Checking (10) illustrated in FIG. 1.

In the event that the Top Correlation Score for the previous top picks as determined by equation (4) is less than a predetermined acceptance value, the final step identified as Run Optimization (130) can be performed. As described in further detail below, in the Run Optimization step the location of each of the top picks for each well is iteratively varied by applying an Optimization Algorithm within a predetermined, but variable range having predetermined upper and lower bounds for all of the wells, and the Well Correlation and Log Correlation Scores are recalculated. The size of the Correlation Window, i.e., the distance between the upper and lower bounds can range from five to ten feet or from one to five feet, or from one to ten feet. The Optimization Algorithm includes several “stopping” criteria. One criterion is reaching a maximum value for the Top Correlation Score, and the other is reaching a minimum threshold for the changes in depth or location of a top. When the maximum Top Correlation Score is achieved, the process is complete with the Re-assessment of Previous Picks (140).

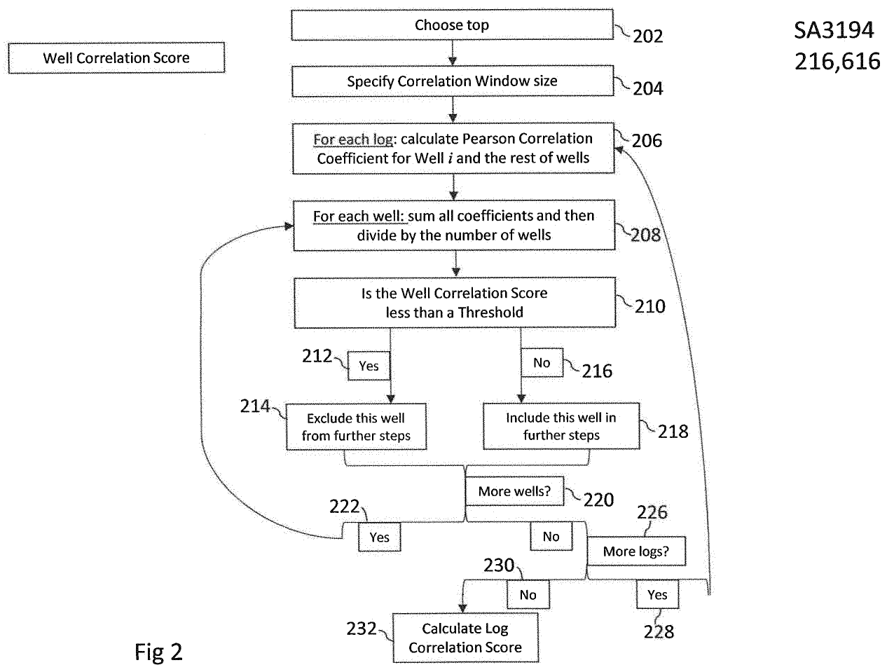

Having provided a summary of the method and system in the description of FIG. 1, the determination of a Well Correlation Score will be described with reference to FIG. 2. As previously explained, a given well can pass through formations that can include more than one top indicative of a hydrocarbon-bearing stratum. In the following description, it will be understood that the top pick can be one of two or more such formation characteristics suggested by the logging data stored in the indexed database for a given well in the defined field.

As shown in the process flow diagram of FIG. 2, the first step in developing the Well Correlation Score is to Choose the Top (202) and to Specify Correlation Window Size (204). Thereafter, For Each Log: Calculate the Pearson Correlation Coefficient (PCC) for Well “i” and the Other Wells in the Field (206). Next, For Each Well: Sum all of the PCCs and divide the Total by the Number of Wells (208). Compare the value calculated in step (208) to a predetermined threshold value (210) to determine if the value is less, and if “Yes” (212), exclude this well (214) from further analysis. If “No” (216), the threshold value is met and the well data is included in the further analyses (218). In the event that the number of wells removed at steps (212, 214) reduces the sample size to less than a predetermined statistically significant number, the decision is made to include More Wells (220), and the process returns to step (208) to determine whether all training well log data have been utilized. In the event that only two wells remain at the end of the process, that log will not be used in further analyses. Once it is determined that no additional well data is needed (224), a determination is made whether any logs remain in the file of a given well to be evaluated (226) and, if “Yes” (228), the process returns to step (206) and is repeated until the “No” (230) determination that no additional log PCC values are needed. The final step is to Calculate the Log Correlation Score (232) for use in the remaining analyses. It is to be noted that steps 220 and 226 are iterative steps, which means the program will keep looping through all wells and all logs in the file until logs have been used in the analysis or quality checking process.

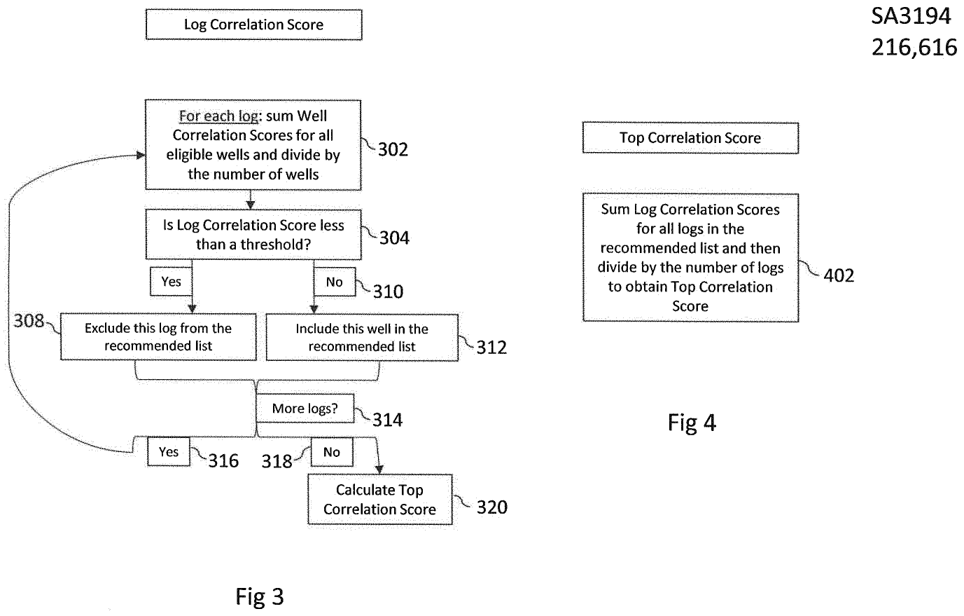

Referring now to the process flow diagram of FIG. 3, the determination of the Log Correlation Score will be described. In the initial step, For Each Log: Sum the Well Correlation Scores for All Eligible Wells and Divide by the Total Number of Wells (302). It will be understood that the term “Eligible Wells”, means those wells that met the predetermined threshold value discussed above. Next, the value of the Log Correlation Scores is compared to determine if it is less than the predetermined minimum or threshold value (304); if “Yes” (306), the log is excluded at (308), and if “No” (310), the log is retained (312) for the further analyses. The number of logs remaining after Step (312) is evaluated to determine whether More Logs (314) remain in the file to be processed and also constitute a significant sample size, and if “Yes” (316), the process is repeated from Step (302); if “No” (318), the Log Correlation Scores retained are used in the determination of the Top Correlation Score. It will be understood that the number of well and/or log data that is required to constitute a “substantially significant sample” in the present context is within the skill in the art.

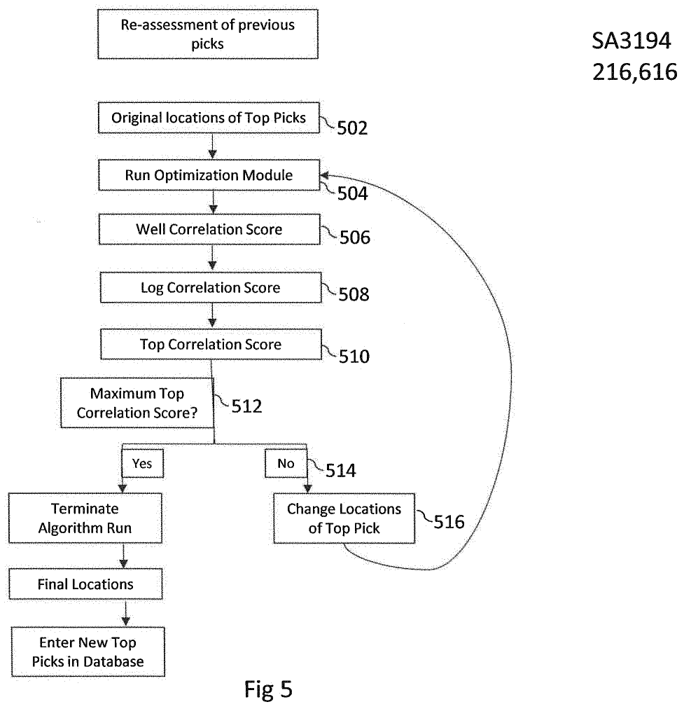

As shown in the Diagram of FIG. 4, the Top Correlation Score is determined by Summing the Log Correlation Scores for retained representative logs and dividing the total by the number of logs (402). It will be understood that if the Top Correlation Score for a given top pick which was originally selected for evaluation in accordance with the present disclosure is of at least a predetermined value, the location of this top pick can be accepted as meeting the objective criteria of this analysis and therefore reliable.

In the event that the value of the Top Correlation Score for the top pick selected for analysis in accordance with this disclosure is less than the predetermined value, and therefore less likely to be reliable, the process illustrated in the flow chart of FIG. 5 can be practiced for the purpose of re-assessing the location of previous top picks. Thus, this step can be advantageously used even where the top Correlation Score is higher than the threshold in order to determine whether there is a better or higher Top Correlation Score for a given top pick. Starting with the Original Location of the Top Picks, iterative adjustments within predetermined bounds are made to the location and a new set of data points are obtained from the indexed well database and the log database as described above in connection with FIG. 1 for the Optimization Run (504). In this step, a series of calculations corresponding to each of the new locations of the top picks provides a new Well Correlation Score (506), Log Correlation Score (508) and the Top Correlation Score (510). After each Optimization Run, the Top Correlation Score is compared to the prior Top Correlation Score (512). If the value of the Top Correlation Score was not improved (514), a further iterative change is made in the location of the top pick (516) and the process is repeated from Step (504). When the Top Correlation Score reaches a maximum value as compared to the scores based on other modifications to the top pick locations, or when a predetermined “Improved Value” is achieved, the Optimization process is concluded, and the new top pick locations are identified in the log database and on electronic and/or printed graphic displays for future use by the geoscientists and production management engineers.

For the purposes of the preferred embodiment of the present disclosure, the stopping criteria are identifying the maximum value, or stopping at the minimum difference between the depths of the new depths and the previous depths.

As will be apparent from the above description of the figures, the present disclosure is directed to a process and method to analyze the historic information and data for wells and all available well logs that is routinely gathered and stored in indexed databases to evaluate the logs in order to establish the reliability of the historic top picks. Thus, one principal advantage of the process of the present disclosure is that data from all of the well logs can be used in determining the location of a selected top.

The identification of the most representative logs includes the step of quantifying the quality of one top pick from the database using different wells and logs by assessing the respective Pearson Correlation Coefficient in accordance with equation (1) as described above. In this process, two correlation scores that are used to determine whether a well and a log has a representative signature for the top pick compared to the rest of the wells and logs in the field are denominated the “Well Correlation Score” and the “Log Correlation Score”, and the determination of their values is described below.

The Well Correlation Score quantifies the “quality” of reliability of the pick using one log and additionally provides a comparison between the other wells in the field.

With the data from the three exemplary types of logs, identified as log a, log b and log c, which can be, for example, Gamma Ray, Porosity and Density, and four wells (Well 1, Well 2, Well 3 and Well 4), a correlation matrix is created for each log, as shown in Table 1, below.

TABLE 1
Well Correlation Score Matrix

| Gamma Ray | Well 1 | Well 2 | Well 3 | Well 4 |
|---|---|---|---|---|
| Well 1 | 1 | 0.952 | 0.601 | 0.92 |
| Well 2 | 0.952 | 1 | 0.52 | 0.85 |
| Well 3 | 0.601 | 0.52 | 1 | 0.63 |
| Well 4 | 0.92 | 0.85 | 0.63 | 1 |
| Well Correlation Score | 0.87 | 0.83 | 0.69 | 0.85 |

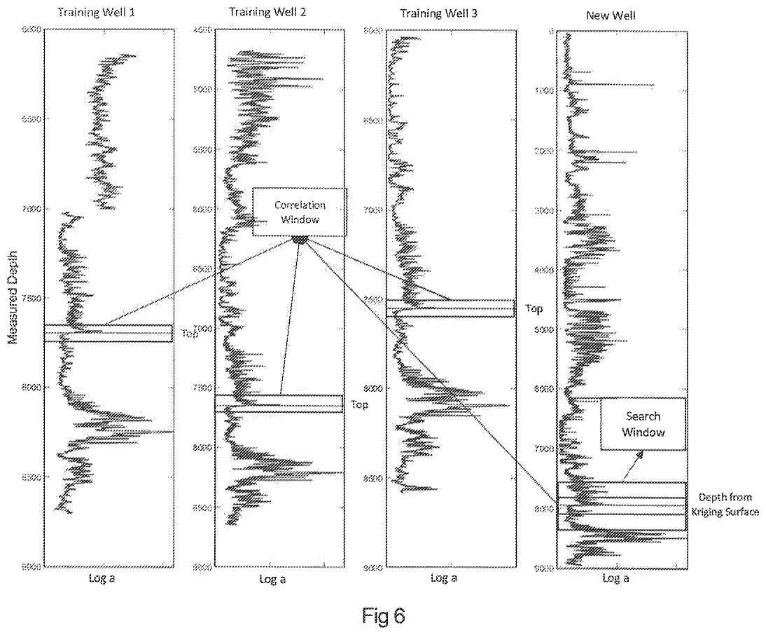

In this example, the matrix is created using equation (1) to calculate the Pearson Correlation Coefficient between Well 1 and Wells 2, 3 and 4 for a relatively small Correlation Window that is defined by the user around the top pick in the database for the gamma ray log. The Correlation Windows are shown on the graphic display of the GR logs for Wells 1-4 in FIG. 6. Next, Well 2 is correlated with the rest of the wells. When all four wells have been correlated with each other, a Well Correlation Score for each well is calculated using the following equation:

$${wcs}_{i} = \frac{{\sum }_{j = 1}^{N} {ρ}_{ij}}{N} \qquad ( 2 )$$

where:

wcsᵢ is the Well Correlation Score for well i;

ρᵢⱼ is Pearson Correlation Coefficient between well i and well j; and

N is the total number of wells.

This process is repeated for all wells and the data from all of the logs. The score must be greater than a predetermined threshold value in order for that well's log data to be used in the further analyses. The threshold value is selected by the geoscientist based on field experience and general statistical experience. Establishing the minimum or threshold value reduces the bias created by the top pick for this well using that log. In the above example, Well 3 in Table 1 has a Well Correlation Score of 0.69 which is less than the 0.7 threshold value specified by the geoscientist at the beginning of this process, and as described below, the gamma ray data for well 3 will not be used in determining the Log Correlation Score.

The Log Correlation Score is a quantitative measure of the quality of the top pick using one log and calculated after the Well Correlation Scores have been determined. Referring to Table 2, a new matrix is prepared using the Well Correlation Scores from the previous step, and the Log Correlation Score is the sum of the Well Correlation Scores, but only for eligible wells that achieve the threshold value, divided by the total number of wells used and as expressed in equation 3 below. This value indicates the quality of the pick and the consistency of the pick across different wells using that log. The results of this analysis provides an indication of whether the geoscientist picked the top at a similar location based on the trend of the data, as distinguished from the value of the depth.

TABLE 2
Log Correlation Score Matrix

| | | | | | Log |
|---|---|---|---|---|---|
| Log | Well Correlation Score | | | | Correlation |
| Name | Well 1 | Well 2 | Well 3 | Well 4 | Score |
| Gamma Ray | 0.87 | 0.83 | — | 0.85 | 0.85 |
| Porosity | 0.81 | 0.90 | 0.70 | 0.92 | 0.83 |
| Density | 0.50 | 0.60 | 0.65 | — | 0.58 |

$${lcs}_{i} = \frac{{\sum }_{j = 1}^{M} {wcs}_{j}}{M} \qquad ( 3 )$$

where:

lcsᵢ is the Log Correlation Score for log i;

wcsⱼ is the Well Correlation Score for well j; and

M is the total number of eligible wells.

As was the case with the Well Correlation Score, a given log value must be higher than a predetermined threshold that is established by the geoscientist. This threshold is used to determine whether or not a log can be included in a list of representative logs, or if it should be excluded or disregarded is not representative. For example, if the density log has a correlation score of 0.58 and the threshold value is 0.70, it will not be included in the logs identified for the further analyses. As shown in Table 2, the Density log doesn't have a consistent pick across Wells 1-3. In this example, it can be seen that the Gamma Ray and Porosity logs can be used in the analysis to identify a given “Top AAA”, because their respective correlation scores are high. The final list represents the logs that have the most consistent pick across different wells.

The results of the previous step that identifies representative logs provides a quantitative assessment of the quality of the picked formation tops that were previously in the database for each of the wells. The assessment indicates whether or not the location of the top pick is consistent across different wells when data from all representative logs is included.

The development of previously drilled and logged wellbores in a given region or field typically occurs over an extended period of time, geophysicists periodically review the previously picked formation tops and modify them, if deemed appropriate, based on enhanced knowledge derived from additional well logging data and actual production records from wells in the same field or region. This reevaluation process takes a significant amount of time since the geoscientists cannot examine and compare data from all wells at the same time. The nature of this stepwise reevaluation process can also lead to errors in the identification of proposed changes to the formation top picks.

In a further embodiment of the present process, changes to improve the reliability of the location of the historical previous top picks can be provided by application of an optimization algorithm that functions to maximize the Top Correlation Score, which as explained above, quantifies the quality of the top pick for each of the wells in the database.

The Top Correlation Score is calculated using different log data from different wells. To obtain this score, the Well and Log Correlation Scores must be calculated. The Top Correlation Score is then calculated as follows:

$${tcs}_{i} = \frac{{\sum }_{j = 1}^{L} {lcs}_{j}}{L} \qquad ( 4 )$$

where:

tcsᵢ is the Top Correlation Score for top i;

lcsⱼ is the Log Correlation Score for log j; and

L is the total number of logs employed in identifying the representative logs.

The optimization algorithm is applied iteratively to maximize the Top Correlation Score by changing the location of the top pick for all of the wells. The new location of the top pick is constrained by predetermined lower and upper bounds that are established by the user. It will be understood that changing the location of the top pick for each well yields different Well and Log Correlation Scores, which in turn, results in a different Top Correlation Score. When the maximum top score is reached, the operation of the optimization algorithm is terminated and the final locations of the respective new optimized top picks for each well are identified for consideration by the geoscientist. The difference between the final optimized top picks and the original depths is calculated by subtracting both values from each other. For example, if the original depth selected for the top pick for Well 1 was 5000 feet and the optimized depth is 5009 feet, then the difference is 9 feet.

The final optimization step is important because each year geoscientists review the prior top picks in the database to reassess and make changes to the top picks in the database based on their enhanced knowledge and experience gained from putting other wells in the field or region into production. As explained above, when the well is put into production, the actual physical depth/location of the top of the hydrocarbon-bearing stratum is known from observing the flow of hydrocarbon gas and/or oil.

Various embodiments of the disclosure have been described above and in the drawings, and other modifications and variations will be apparent to those of ordinary skill in the art, and the scope of protection to be accorded the invention is to be determined with reference to the claims that follow.

I claim:

1. A method for quantifying by ranking the relative quality of a selected formation top pick for a specific well A in a defined oil field based on an analysis of selected from historical data maintained in indexed databases containing:
a. information identifying a plurality of existing wells and including well A in the defined oil field by location and physical characteristics,
b. well logging data derived from a plurality of logging devices obtained during the drilling of, and associated in the databases with each of the wells in the defined oil field, and
c. the location of at least one top pick for each well in the defined oil field, the method comprising the steps of
i. specifying the linear dimension between the upper and lower bounds of a correlation window that defines a region above and below the location of the well A selected top pick for which region well logging data is available for analysis in the indexed databases, the well logging data being that derived from each of the plurality of logging devices produced during the drilling of well A;
ii. collecting the data from the correlation window for each of the plurality of logs for well A and for all other of the plurality of wells;
iii. calculating the Pearson Correlation Coefficient for each of the logs for well A, and for all other of the plurality of wells in the defined oil field in accordance with equation (1);
iv. for each of the plurality of wells, determining a Well Correlation Score for each log in comparison with the logs from the plurality of wells in accordance with equation (2) to provide a Well Correlation Score;
v. preparing a matrix of the Well Correlation Scores for each of the logs and each of the plurality of wells in accordance with equation (3) to provide a Log Correlation Score for each of the respective logs across all of the plurality of wells;
vi. comparing each Log Correlation Score to a predetermined threshold value and excluding any log that is less than the threshold value from subsequent analyses, where the remainder of the logs having a Log Correlation Score equal to, or greater than the threshold value are designated representative logs;
vii. summing the Log Correlation Scores for all representative logs and dividing the sum by the total number of representative logs in accordance with equation (4) to obtain a Top Correlation Score for each log for each of the plurality of wells; and
viii. listing the values of the Top Correlation Scores for each of the wells in descending numerical order to thereby provide a ranking of the relative reliability of the location of the formation top picks for each of the plurality wells, including well A.

2. The method of claim 1 in which the plurality of wells comprises at least three wells located in the defined oil field.

3. The method of claim 1 in which the logging devices include logging tools for collecting gamma ray data, porosity data, density data.

4. The method of claim 1 in which the linear dimension of the correlation window is determined based on predetermined criteria including well log data from producing wells in the defined oil field for which the actual formation top of a hydrocarbon-bearing stratum has been determined by direct observation of the onset of produced hydrocarbons.

5. The method of claim 4 in which the linear dimension of the correlation window is from one to ten feet.

6. The method of claim 1 in which the threshold value of the Well Correlation Score in step c.vi is 0.7.

7. The method of claim 1 in which the threshold value of the Log Correlation Score in step c.vii is 0.7.

8. The method of claim 1 in which the indexed database includes logging data corresponding to the known location of one or more top picks identified when a well in the defined oil field was put into production.

9. The method of claim 1 in which the Top Correlation Score for the top picks is recalculated periodically for the wells in the defined oil field that have not been put into production, where the indexed databases include data from production records of actual formation tops of wells put into production in the interim.

10. The method of claim 1, which includes the additional steps of:
a. establishing a minimum value for the Top Correlation Score as determined by equation (4) and identifying low scoring wells having a Top Correlation Score that is lower than the minimum value;
b. iteratively varying the location of each of the top picks for each well by applying an optimization program that varies the size of the Correlation Window within a predetermined variable range of upper and lower bounds;
c. calculating the Well Correlation Score and the Log Correlation Score for each location in the iterative process;
d. calculating a new Top Correlation Score for each iterative location;
e. comparing each new Top Correlation Score for each of the low scoring wells, and terminating the iterative process when either of the following occurs:
i. the value of the Top Correlation Score is maximized for the location, or
ii. a minimum threshold is reached for the changes in the depth of the location of a top;
f. recording the revised Top Correlation Score and location of the top pick for the well in the database.
